(19) United States
(12) Patent Application Publication
(10) Pub. No.: US 2023/0305279 A1
(43) Pub. Date: Sep. 28, 2023

(54) OPTICAL UNIT, SPECTROSCOPIC ANALYZER, OPTICAL DEVICE, AND METHOD FOR MANUFACTURING OPTICAL UNIT

(71) Applicant: CANON KABUSHIKI KAISHA, Tokyo (JP)

(72) Inventors: MASATSUGU KOYAMA, Kanagawa (JP); TOSHIMITSU NAGOYA, Kanagawa (JP)

(21) Appl. No.: 18/181,887

(22) Filed: Mar. 10, 2023

(30) Foreign Application Priority Data
Mar. 22, 2022 (JP) 2022-045094

(51) Int. Cl. G01J 3/02

(52) U.S. Cl. CPC G01J 3/0262; G01J 3/0208; G01J 3/021

(57) ABSTRACT

An optical unit includes a reflective optical element and an antireflection structure having an average height and an average pitch larger than a maximum wavelength of light contained in an effective light flux. The antireflection structure is disposed outside an optical path of the effective light flux, and the antireflection structure has a plurality of convex portions extending in a predetermined direction. An angle formed between the predetermined direction and the optical path of the effective light flux is from 45 degrees to 60 degrees.

### BACKGROUND OF THE INVENTION

### Field of the Invention

The present invention relates to an optical unit and the like having an antireflection structure.

### Description of the Related Art

In a field of an optical device, attempts have been made to reduce a size of the device while securing an optical path length by using an optical unit that bends or folds an optical path. In particular, in the fields of astronomical telescopes, microscopes, various cameras, and the like including a spectroscopic analyzer, there is a demand for an optical unit that is downsized while securing an optical path length by repeatedly reflecting light beams according to conditions such as a size of an aperture, required spectral performance, and a diffraction distance.

Meanwhile, in the field of image display apparatuses and the like, an antireflection means using a so-called moth-eye structure is known. In the moth-eye structure, a large number of minute conical protrusions are arranged at a pitch equal to or less than a shortest wavelength of a wavelength band for preventing reflection, and an effective refractive index with respect to incident light is continuously changed to eliminate a refractive index discontinuous interface, thereby obtaining the antireflection effect.

JP 2014-6390 A describes that in a moth-eye structure in which minute protrusions are arranged on a transparent substrate at a pitch smaller than a shortest wavelength in a visible light region, the minute protrusions are inclined from a normal direction with respect to a surface of the transparent substrate.

In an optical unit that repeatedly reflects light beams to secure an optical path length, it is necessary to lay out an internal structure so that a structure supporting a reflecting member or the like does not interfere with the optical path. In order to miniaturize the optical unit, an available inner space is limited, and thus, it is difficult to freely arrange a diaphragm for cutting unnecessary light. Then, unnecessary light deviated from a principal light beam by a minute angle may travel inside the optical unit outside an effective light flux. When such unnecessary light collides with, for example, a structural material supporting the reflecting member and is reflected, the reflected light may become stray light. Furthermore, when the reflected light collides with another member and is reflected, stray light having a further different traveling direction may be generated. When a part of the stray light is superimposed on the effective light flux, the effective light is observed in a state where a quality of information is deteriorated by superimposing the stray light.

Therefore, it is conceivable to provide antireflection means in advance at a location where unnecessary light collides. For example, it is conceivable to apply a black paint to the relevant location. However, since gas and organic substances are generally generated from the covered black paint over a long period of time, and there is a possibility of contaminating an optical surface of an optical element and a light receiving surface of a sensor, the black paint is not a preferable antireflection means.

In addition, in a case where the moth-eye structure is used as the antireflection means, it is necessary to form a microstructure having a wavelength equal to or less than the shortest wavelength of a wavelength band in which the antireflection is performed, and to form a structure in which an effective refractive index with respect to a target wavelength continuously changes. However, it is not easy to produce the microstructure having a wavelength equal to or less than the shortest wavelength. In addition, in the case of the moth-eye structure, in order to continuously change the effective refractive index, a direction (axial direction of the cone) in which a conical protrusion protrudes from a substrate is preferably parallel to the direction in which the light is incident, but in this case, specular reflection is likely to occur at a vertex of the protrusion.

For example, in the moth-eye structure in which the axial direction of the cone is adjusted to the incident direction of the stray light by the method of JP 2014-6390 A, since a large number of protrusions are arranged at a fine pitch equal to or less than a wavelength of objective light, it can be said that the arrangement density of vertexes where the specular reflection occurs is high and specular reflection easily occurs. Therefore, the antireflection effect by the moth-eye structure tends to be insufficient. In addition, in the moth-eye structure, when the incident direction of light is deviated from the axial direction of the cone, the reflectance tends to greatly increase.

Therefore, in an optical unit that reflects the light beam to secure the optical path length, realization of an antireflection means capable of suppressing generation of stray light has been expected.

### SUMMARY OF THE INVENTION

According to a first aspect of the present invention, an optical unit includes a reflective optical element and an antireflection structure having an average height and an average pitch larger than a maximum wavelength of light contained in an effective light flux, disposed outside an optical path of the effective light flux, including a plurality of convex portions extending in a predetermined direction. An angle formed between the predetermined direction and the optical path of the effective light flux is from 45 degrees to 60 degrees.

Further features of the present invention will become apparent from the following description of exemplary embodiments with reference to the attached drawings.

### BRIEF DESCRIPTION OF THE DRAWINGS

FIG. 1 is a diagram illustrating a configuration of an optical unit 10 according to a first embodiment.

FIG. 2 is a schematic perspective view for explaining an antireflection structure according to the embodiment.

FIG. 3A is a diagram for explaining that generation of stray light is suppressed by the antireflection structure according to the embodiment.

FIG. 3B is a diagram illustrating an example in which an antireflection structure 20 is provided beside a transmission portion 18 provided in a structural member 13.

FIG. 4A is a diagram illustrating an example in which an antireflection structure 20 is provided on a surface of a support unit 12.

FIG. 4B is a diagram illustrating an example in which the antireflection structure 20 is provided in a cover member.

FIG. 5 is a schematic diagram for explaining a reflectance measurement system.

FIG. 6 is a graph illustrating a relationship between an incident angle and an average reflectance.

FIG. 7 is a view illustrating an electron micrograph of an antireflection structure.

FIG. 8 is a diagram illustrating a configuration of an optical unit 60 according to a second embodiment.

FIG. 9 is a diagram illustrating a configuration of an optical unit 70 according to a third embodiment.

FIG. 10 is a diagram illustrating a configuration of an optical unit 80 according to a fourth embodiment.

### DESCRIPTION OF THE EMBODIMENTS

A plurality of embodiments of an optical unit including an antireflection structure according to the present invention will be described with reference to the drawings. The following embodiments and examples are examples, and for example, detailed configurations can be appropriately changed and implemented by those skilled in the art without departing from the gist of the present invention.

The present invention can be applied to various optical devices, and particularly, can be suitably implemented in various optical devices including a spectroscopic analyzer, such as an astronomical telescope, a microscope, and various cameras. For example, the present invention is suitably implemented in an optical unit including a reflective optical element such as a mirror, a reflection type diffraction grating, or a transmissive inner reflection type diffraction grating, and configured to ensure an optical path length by reflecting an effective light flux. Here, the effective light flux refers to a light flux to be utilized according to the application and use purpose of the optical device among light incident on the optical device, and does not refer to light unnecessary in light of the application and use purpose. For example, in the case of a spectroscopic analyzer, the effective light flux refers to a light flux to be guided to the light receiving element. According to the present embodiment, it is possible to suppress generation of stray light due to reflection of unnecessary light deviating from a principal light beam by a minute angle on the member, and thus, it is possible to prevent deterioration in performance of the spectroscopic analyzer. In the drawings referred to in the following description of the embodiments and examples, elements denoted by the same reference numerals have the same functions unless otherwise specified.

### First Embodiment

An optical unit including an antireflection structure according to a first embodiment will be described with reference to the drawings. Note that, in the drawings referred to below, there is a portion schematically represented for convenience of illustration and description, and thus, there is a case where the shape, size, arrangement, and the like are not exactly matched with the actual shape, size, arrangement, and the like.

### Configuration of Optical Unit

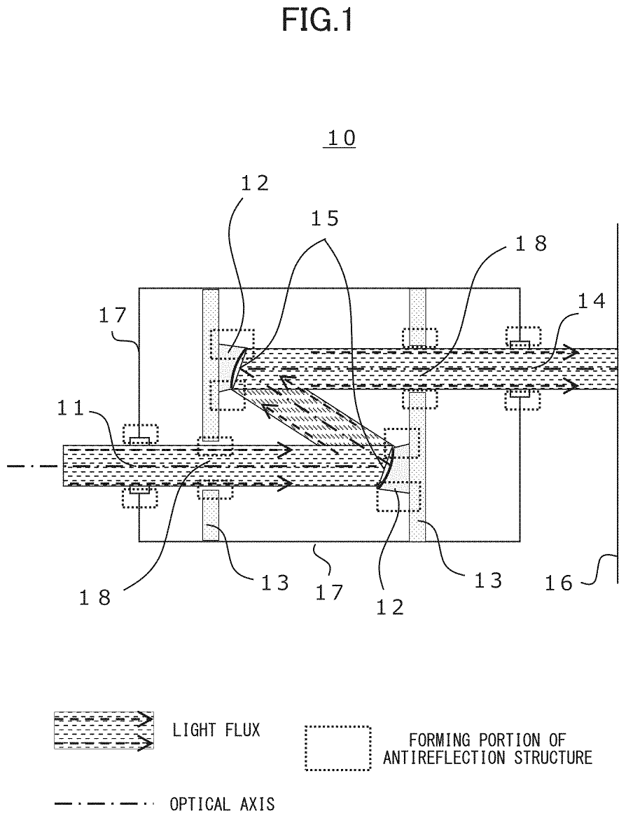

FIG. 1 is a diagram illustrating a configuration of an optical unit 10 according to a first embodiment. The optical unit 10 includes an incidence portion 11, a support unit 12, a structural member 13, an emission portion 14, a reflection unit 15, and a light receiving element 16. The optical unit causes a light flux to enter from the incidence portion 11, reflects the light flux by the two reflection units 15 to change an optical path, and then emits the light flux from the emission portion 14 to guide the light flux to the light receiving element 16. In the drawing, a light flux is indicated by a dotted arrow, and an optical axis is indicated by a one-dot chain line. In this example, the long optical path length is secured by folding the optical path by the reflection units 15 provided at two locations, but a configuration may be adopted in which a large number of reflection units are further provided to increase the number of times of folding.

The incidence portion 11 is a portion that causes a light flux including optical information, image information, or the like from an object surface to be incident into the optical unit, and is configured as, for example, an opening provided in the casing 17 or a transmission window made of a material that transmits objective light.

The reflection unit 15 for reflecting a light flux in a predetermined direction is disposed on the optical path. Each reflection unit 15 may be a mirror having a single optical surface or a mirror array having a plurality of optical surfaces. By forming a reflecting surface of the reflection unit 15 into a predetermined curved surface shape, the light flux can be shaped into a desired diameter or a desired cross-sectional shape. The reflection unit 15 is positioned and fixed to the structural member 13 via the support unit 12.

Note that the mirror may be a mirror in which a reflection film is formed by, for example, plating for optical use containing copper or nickel or aluminum vapor deposition, or an enhanced reflection film may be provided on the surface. The enhanced reflection film may be a film containing any of gold, silver, and aluminum, and may be provided with an oxide film of silicon oxide, titanium oxide, alumina, or the like.

The structural member 13 is a member constituting a framework of the optical unit together with the casing 17. Since an inner space of the optical unit is limited, the structural member 13 is provided with a transmission portion 18 for allowing a light flux to pass therethrough as necessary. The transmission portion 18 is formed as an opening portion or a concave portion in the structural member 13, for example, but may be configured by attaching a transmission window made of a material that transmits a light flux to the structural member 13 in some cases.

The emission portion 14 is an extraction portion for extracting a light flux from the optical unit, and is formed as, for example, an opening provided in the casing 17, but may be configured by attaching a transmission window made of a material that transmits a light flux to the casing 17.

The light receiving element 16 is an element that receives a light flux and converts the light flux into an electric signal, and an element suitable for the application of the optical device is used. Typically, an imaging element such as a CMOS sensor or a CCD element capable of measuring an intensity distribution of light in a light flux cross section is used, but other elements may be used.

### Arrangement of Antireflection Structure

In the optical unit illustrated in FIG. 1, an antireflection structure is provided on outer surfaces of portions surrounded by dotted lines in the drawing in order to prevent unnecessary light deviated from a principal light beam by a minute angle from generating stray light. Details of the antireflection structure according to the present embodiment will be described later in detail, and first, a position at which the antireflection structure is suitably provided will be described.

First, there is a case where the incidence portion 11 on which the light flux emitted from the object surface is incident serves as a pupil for cutting out an effective light flux (for example, a necessary image portion). Therefore, in a case where the incidence portion 11 is an opening formed in the casing 17, the antireflection structure is provided on an edge portion surface around the opening that may be irradiated with unnecessary light or an inner surface of a hole penetrating the casing 17. In a case where the incidence portion 11 is a transmission window made of a material that transmits a light flux, the antireflection structure is provided on the surface of the casing 17 around the transmission window that may be irradiated with unnecessary light.

In addition, when the structural member 13 in the optical unit is provided with the transmission portion 18 for passing a light flux, the transmission portion 18 may also serve as a pupil for cutting out an effective light flux (for example, a necessary image portion). Therefore, in a case where the transmission portion 18 is an opening formed in the structural member 13, the antireflection structure is provided on an edge portion surface around the opening that may be irradiated with unnecessary light or an inner surface of a hole penetrating the structural member 13. In a case where the transmission portion 18 is a transmission window made of a material that transmits a light flux, the antireflection structure is provided on the surface of the structural member 13 around the transmission window that may be irradiated with unnecessary light.

Furthermore, the reflection unit 15 may also serve as a pupil for cutting out an effective light flux (for example, a necessary image portion). Therefore, the antireflection structure is provided on the surface of the support unit 12 that may be irradiated with unnecessary light or the surface of the structural member 13 to which the support unit 12 is fixed.

In addition, the emission portion 14 that emits the light flux may also serve as a pupil for cutting out the effective light flux (for example, a necessary image portion). Therefore, when the emission portion 14 is an opening formed in the casing 17, the antireflection structure is provided on an edge portion surface around the opening that may be irradiated with unnecessary light or an inner surface of a hole penetrating the casing 17. In a case where the emission portion 14 is a transmission window made of a material that transmits a light flux, the antireflection structure is provided on the surface of the casing 17 around the transmission window that may be irradiated with unnecessary light.

In the portion where these antireflection structures are provided, unnecessary light located outside the effective light flux may irradiate the surface of the member. When such unnecessary light is reflected by the surface of the member, the reflected light itself becomes stray light, and the reflected light is further reflected by the surface of another member to secondarily generate stray light.

The unnecessary light incident from the outside of the effective light flux is often a light beam deviated from an optical axis direction by a minute angle. For example, in the case of irradiating the edge portion surface around the opening of the casing 17 or the structural member 13 or the periphery of the transmission window, irradiation is performed at a relatively small incident angle. Even when the moth-eye structure is provided in this portion, as described above, specular reflection is likely to occur at the vertex of minute cones arranged at high density in the moth-eye structure, so that it cannot be expected that the generation of stray light is sufficiently suppressed in the moth-eye structure.

In addition, in a case where the inner surface of the hole penetrating the casing 17 or the structural member 13 is irradiated with the unnecessary light, the unnecessary light is incident at a large incident angle. However, when the antireflection structure is not provided, the incident angle is large, and thus, there is a high possibility that reflection becomes dominant and stray light is generated. In addition, even when the moth-eye structure is provided in this portion, in a case where an axial direction of the conical protrusion is perpendicular to the inner surface of the hole, a structure in which a refractive index continuously changes with respect to the traveling direction of the unnecessary light is not obtained. Therefore, a sufficient antireflection effect cannot be expected due to incident angle dependence. Meanwhile, it is not easy to form extremely minute cones arranged at a fine pitch equal to or less than the shortest wavelength so as to be inclined such that the axial direction of the cones approaches the optical axis direction as in JP 2014-6390 A on the inner surface of such a hole. Even when it is possible to incline, specular reflection is likely to occur at the vertexes of cones arranged at a high density as described above, so that it cannot be expected that the generation of stray light is sufficiently suppressed in the moth-eye structure.

In addition, there is a high possibility that stray light is generated also in a case where the surface of the support unit 12 that supports the reflection unit 15 or the surface of the structural member 13 to which the support unit 12 is fixed is irradiated with unnecessary light. As described above, since the antireflection function of the moth-eye structure has angle dependency, it is necessary to bring the axis of the cone close to the optical axis direction. However, even when the antireflection function can be achieved, specular reflection is likely to occur at the vertexes of cones arranged at a high density. Therefore, it cannot be expected that the generation of stray light is sufficiently suppressed.

Therefore, in the present embodiment, an antireflection structure different from the moth-eye structure is provided at these portions. Hereinafter, the antireflection structure according to the present embodiment will be described.

### Antireflection Structure

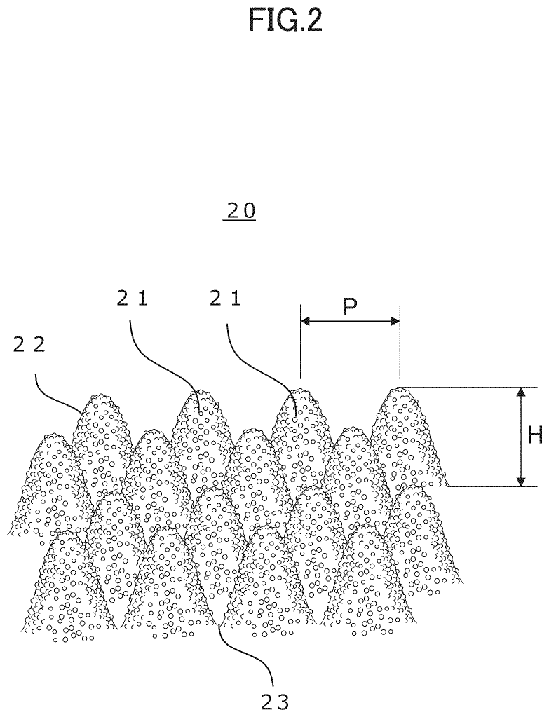

FIG. 2 is a schematic perspective view for explaining an antireflection structure 20 according to the present embodiment. The antireflection structure 20 includes a large number of convex portions 21 formed on a base surface. In the example of FIG. 2, a large number of convex portions 21 are formed on a flat base surface, but the base surface (that is, a base portion which is a base of the convex portions 21) is not necessarily a flat surface, and may be, for example, a curved surface.

As the material of the convex portion 21, for example, a material containing a metal such as iron, stainless steel, aluminum, copper, or titanium, or an alloy thereof as a main component can be used. On the surface of the convex portion 21, a film having an absorbing capability for light having a target wavelength, for example, a metal oxide film or an alloy oxide film may be formed. The surface of the convex portion 21 may be smooth, but may be a rough surface on which minute irregularities 22 are formed. For example, according to the method of forming the convex portion 21 by laser processing in the atmosphere, it is possible to simultaneously form an oxide film having an absorbing capability of unnecessary light on the surface of the convex portion 21, and thus, it is possible to manufacture an excellent antireflection structure with high mass productiveness.

An average height H of the convex portions 21 and an average pitch P between the convex portions are configured on a larger scale than cones used for the moth-eye structure. In the moth-eye structure, fine cones are arranged at a pitch smaller than the shortest wavelength of the objective light, so that the effective refractive index continuously changes to eliminate the discontinuous interface of the refractive index, thereby obtaining an antireflection effect. Meanwhile, in the present embodiment, in the structure including the convex portion 21 having a scale larger than that of the moth-eye structure, the objective light is absorbed while being multiple-reflected, and is suppressed from being reflected in a direction to become stray light. A pitch (for example, average pitch) between the convex portions in the present embodiment is set to be larger than a maximum wavelength of light guided to the light receiving element 16. Specifically, the average height of the vertexes of the convex portions and the average pitch between the vertexes of the convex portions are desirably 1 μm or more and 100 μm or less. When the average height and the average pitch are less than 1 μm, a wavelength at which reflection is desired to be prevented, that is, for example, a pitch close to a maximum wavelength of light handled by a spectroscopic device is obtained, a diffraction phenomenon of light occurs, and reflection prevention using multiple reflection assumed and a behavior of light change. Moreover, when the average height and the average pitch are more than 100 μm, a space occupied by the convex portion increases, which is not suitable for downsizing the device. In addition, it is difficult to form the convex portion by laser processing excellent in mass productiveness.

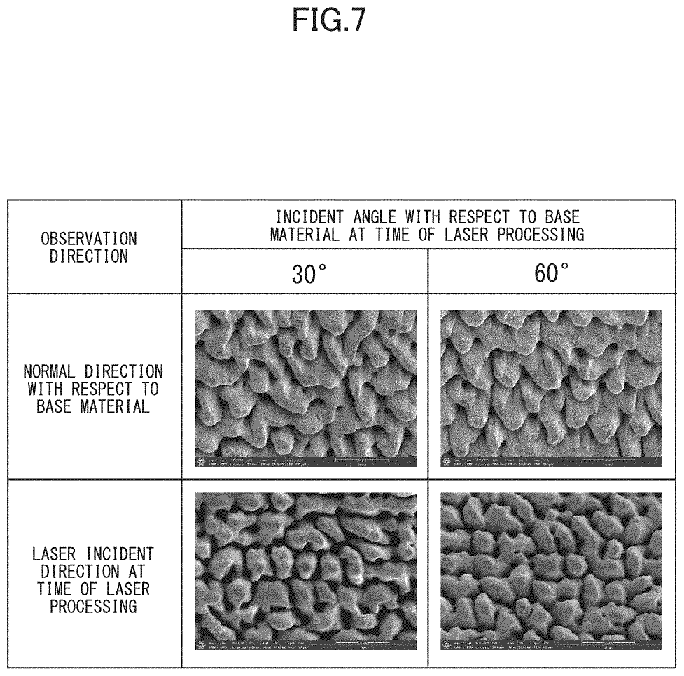

In the example of FIG. 2, the plurality of convex portions 21 are regularly arranged along the grid point, but the arrangement of the convex portions is not necessarily limited to this example. An arrangement having high geometric regularity such as a honeycomb or a staggered arrangement may be used. Note that, as illustrated in a photograph posted in FIG. 7 to be described below, statistical values (for example, an average value and a variance) of the height and the pitch are included in a predetermined range, but the regularity of geometrically observed shapes may be small. From the viewpoint of the antireflection function and the ease of manufacturing, the example illustrated in FIG. 7 is preferable. That is, the convex portion 21 is not limited to a conical shape in which a curvature near the apex is blunted as illustrated in FIG. 2. However, regardless of the shape, the average height H of the convex portions 21 and the average pitch P between the convex portions are set to be larger than the maximum wavelength of the light guided to the light receiving element 16.

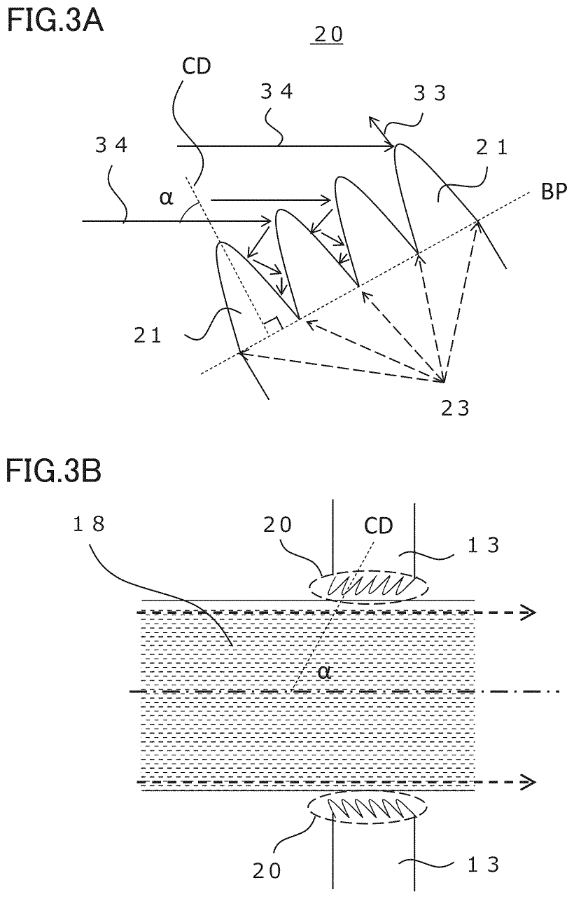

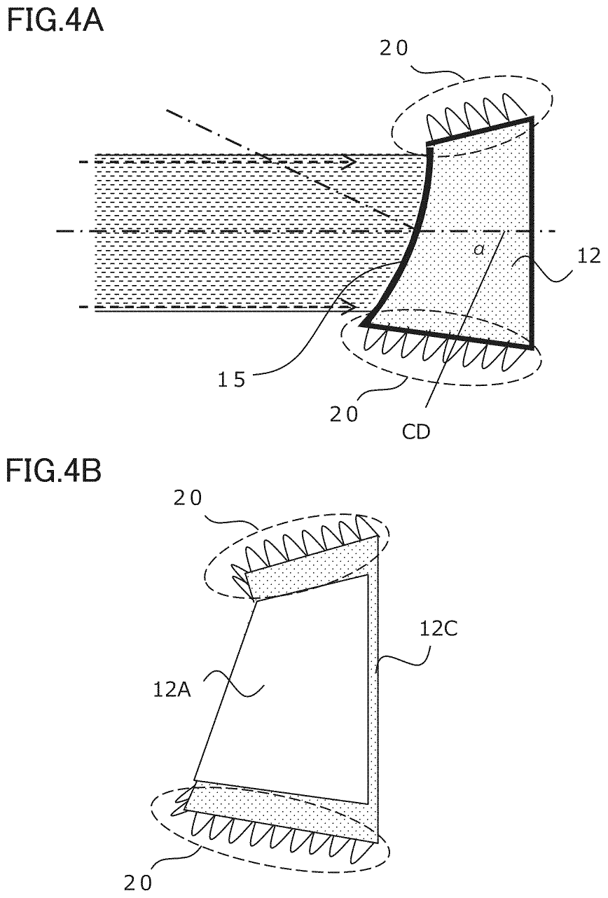

FIG. 3A is a diagram for explaining that the antireflection structure according to the present embodiment suppresses generation of stray light. When a direction in which the convex portion 21 extends is denoted by CD, CD is a direction perpendicular to a base surface BP in this example. Here, the base surface BP is a virtual surface formed by connecting the boundaries 23 between the convex portions 21. In the example illustrated in FIG. 3A, CD is perpendicular to the base surface BP However, as illustrated in FIG. 3B and FIG. 4A to be referred to below, the direction of CD may be set to an angle other than perpendicular to the base surface BP. As will be described below, for example, in a case where the convex portion is formed by laser processing, an extension direction of the convex portion 21 with respect to the base surface BP can be controlled by the laser irradiation direction.

It is assumed that a direction in which the objective light 34 whose reflection is desired to be suppressed is incident is defined by an angle a with respect to CD. Note that the direction in which the objective light whose reflection is desired to be suppressed enters the portion (for example, portion surrounded by a dotted line in FIG. 1) where the antireflection structure is provided may be approximated to be parallel to the optical axis direction (optical path) of the effective light flux. In the antireflection structure of the present embodiment, an incident angle a of the objective light is desirably 45 degrees or more and 60 degrees or less with respect to CD. In the present embodiment, in order to prevent the objective light from being reflected and escaping as stray light, as illustrated in the drawing, the objective light is first made to hit a slope of the convex portion 21, and the reflected light is gradually absorbed and attenuated by the convex portion while being repeatedly reflected between adjacent convex portions. In the present embodiment, since the pitch between the convex portions is larger than that of the moth-eye structure, a density of the apexes generating the reflected light 33 escaping to the outside is small. Meanwhile, in order to increase a rate of light attenuated by repeated reflection between the convex portions, a is preferably set to 45 degrees or more and 60 degrees or less.

In the case of the moth-eye structure, a structure smaller than a wavelength region to be suppressed is formed, and the refractive index change is made gentle to suppress the reflected light, so that antireflection performance is affected by wavelength dependence of the refractive index of the base material. Since the scale of the convex portion in the present embodiment is larger than the wavelength of the objective light, antireflection performance is hardly affected by the wavelength dependence of the refractive index of the base material. In an analysis device such as a microscope, a telescope, or FT-IR, a direction in which the objective light desired to be prevented from being reflected is incident is limited, and may be considered to be substantially parallel to the optical axis. Therefore, it can be said that a structure in which a is set to 45 degrees or more and 60 degrees or less with respect to the optical axis is easy to design and is very effective.

FIG. 3B is a diagram illustrating an example in which the antireflection structure 20 is provided beside the transmission portion 18 (see FIG. 1) provided in the structural member 13. As illustrated in the drawing, the convex portions are provided on the inner surface of the opening of the transmission portion 18 in such a direction that α is 45 degrees or more and 60 degrees or less with respect to the optical axis at an average pitch of 1 μm or more and 100 μm or less. Even when unnecessary light substantially parallel to the optical axis exists on the outer side of the effective light flux and the inner surface of the through hole of the structural member 13 is irradiated with the unnecessary light, it is possible to suppress generation of reflected light that becomes stray light. Also, in a case where the antireflection structure is provided beside the incidence portion 11 and the emission portion 14 provided in the casing 17, the antireflection structure 20 in which convex portions are formed in the same direction and pitch is provided on the inner surface and the edge of the opening.

In addition, when the antireflection structure 20 is provided on the surface of the support unit 12 that supports the reflection unit 15 or the surface of the structural member 13 to which the support unit 12 is fixed, the convex portions are provided at a pitch of 1 μm or more and 100 μm or less in a direction in which a is 45 degrees or more and 60 degrees or less with respect to the optical axis. Any one of a low thermal expansion invar material, a stainless-steel material, and aluminum can be suitably used as the material of the support unit 12 and the structural member 13.

FIG. 4A illustrates an example in which convex portions are provided as the antireflection structure 20 at an average pitch of 1 μm or more and 100 μm or less in a direction in which a is 45 degrees or more and 60 degrees or less with respect to the optical axis on the surface of the support unit 12 that supports the reflection unit 15. Even when the unnecessary light substantially parallel to the optical axis exists on the outer side of the effective light flux and the surface of the support unit 12 is irradiated with the unnecessary light, it is possible to suppress generation of reflected light that becomes stray light.

In addition, the antireflection structure 20 does not have to be formed directly on the support unit 12, and may be formed on another member that covers the support unit 12. FIG. 4B illustrates an example in which the antireflection structure 20 is formed on a cover member 12C capable of covering the support unit 12. When a concave portion 12A of the cover member 12C is fitted and attached to the support unit 12, an antireflection effect similar to that obtained by directly forming the antireflection structure 20 on the support unit 12 can be obtained. As described above, the method in which the antireflection structure is formed as a separate member and a portion where stray light is not desired to be generated is covered with the separate member is advantageous in that the antireflection structure and the material of the base thereof can be freely selected. In addition, there is an advantage that handling of a portion where stray light is not desired to be generated becomes simple by retrofitting a separate member on which the antireflection structure is formed. For example, a material having a main component according to the application of the optical unit, such as iron, aluminum, copper, or an alloy, is used, and for example, a plate material having a thickness of 1 mm is formed into a sheet metal, and the surface is subjected to laser processing to form an antireflection structure, thereby forming a cover member.

In addition, for example, a previously formed antireflection structure may be transferred to a member made of a film-like or sheet-like resin material to be used as a cover member. In order to transfer the antireflection structure, for example, a method can be used in which an antireflection structure is formed in a roll mold, and a photocurable resin material is applied in a film shape or a sheet shape, cured, and transferred. A film-shaped or sheet-shaped resin member having an antireflection structure can be attached to a place where reflection of the optical unit is to be prevented by bonding or bonding.

The present embodiment can be suitably implemented in various optical devices including a spectroscopic analyzer, for example, an optical unit built in an astronomical telescope, a microscope, various cameras, or the like. According to the present embodiment, it is possible to suppress generation of stray light due to reflection of unnecessary light deviating from the principal light beam by a minute angle on the member, and thus, it is possible to effectively prevent deterioration in performance of the spectroscopic analyzer.

### EXAMPLES

An example in which the antireflection structure according to the first embodiment is implemented will be specifically described. The antireflection structure 20 schematically illustrated in FIG. 2 can be manufactured by a processing method of irradiating a base material (parent material) with a short pulse laser having a pulse width of 10⁻¹² seconds or less to roughen the surface. By setting the pulse width of the machining laser to 10⁻¹² seconds or less and performing irradiation with a peak power of 1 MW or more, a local temperature gradient is generated in a base material (parent material) whose main component is a metal or an alloy, and a difference in surface tension is generated, whereby a convex portion can be efficiently generated. It is also possible to form an oxide film in which the material of the base material surface is bonded to oxygen in the atmosphere (for example, the air) in which oxygen exists on the surface of the convex portion 21 by irradiating the laser in the atmosphere. By forming the oxide film, light can be effectively absorbed in the process of repeating the reflection illustrated in FIG. 3A. The minute irregularities 22 on the surface of the convex portion 21 can be formed by scattering and reattaching high-temperature vapor or fine particles of a workpiece during laser processing.

In order to generate the antireflection structure by laser processing using a short pulse laser, for example, a material of a main component according to the application of the optical system, such as iron, aluminum, copper, or an alloy material, can be used as a parent material. In Examples, an SUS alloy was used. The short pulse laser used here refers to a laser that repeats irradiation with a short pulse, unlike a laser that performs continuous irradiation. Among short pulse lasers, those that emit pulses of several picoseconds to several 100 picoseconds may be referred to as picosecond lasers. In addition, a laser that emits pulses of several femtoseconds to several 100 femtoseconds less than 1 picosecond may be referred to as a femtosecond laser. In Examples, the picosecond laser and the femtosecond laser are suitably used.

As a laser processing device, a device capable of arbitrarily selecting conditions such as laser irradiation intensity, pulse length, and pulse interval is used. For example, an ultrashort pulse laser oscillator manufactured by AMPLITUDE SYSTEMS can be used. The wavelength of the processing laser generated by such an ultrashort pulse laser oscillator is set to 1030 nm, and the pulse width thereof is selected to be 350 fs (femtosecond). In addition, the energy per pulse of the processing laser is set to 40 a lens having a focal length of about 170 mm is used, and the distance between the lens and the base material surface is adjusted to adjust the spot diameter of the irradiation area to 40 μm. The area of the irradiation area of one pulse is approximately 1.3×10⁻³ [mm²], and the energy density per pulse of the laser in the irradiation area is approximately 30 [kJ/m²]. A galvano scanner is also used to scan the laser to selectively process the regions forming the antireflection structure. A scanning rate of the galvano scanner is, for example, 1000 [mm/sec], and a repetition frequency of the laser is 1000 [kHz]. The time interval of the pulses is 1 [μsec], and the interval of the irradiation positions is 2 [μm].

As illustrated in FIGS. 3B and 4A, at the position where the antireflection structure 20 is provided, the direction in which the convex portion extends from the base material (base surface BP) is controlled such that the angle a formed by the optical axis of the objective light and CD, which is the direction in which the convex portion extends, is within a predetermined range. CD, which is the direction in which the convex portion extends, can be controlled by the incident angle when the base material surface is irradiated with the machining laser beam. By appropriately controlling the incident angle of the processing laser, the pulse width, the repetition frequency, the scanning rate, the energy density of the irradiation spot, and the like, it is possible to control the direction in which the convex portion extends and the average height and the average pitch of the convex portion. According to such a laser processing method, it is possible to manufacture an antireflection structure having a special shape, which is difficult to realize by a method such as cutting, with high mass productiveness.

FIG. 7 illustrates an electron micrograph of the antireflection structure in which the direction in which the convex portion extends is controlled. The laser processing device is driven under the conditions described above, and the formed convex portion is compared for the cases where the incident angle of the laser with respect to the SUS base material is 30 degrees and 60 degrees. In the image observed from the laser incident direction at the time of laser processing, the entire region from the vertex to the skirt of the convex portion can be observed, so that it can be seen that the convex portion extends in the observation direction. Meanwhile, when the images observed from the normal direction with respect to the base material surface are compared, it is observed that the extension directions of the convex portions are clearly different. For these samples, the average height and average pitch of the convex portions were measured. As a result of measurement using a laser microscope vx-3000 manufactured by Keyence Corporation, it was found that the average pitch was in a range of 20 μm or more and 50 μm or less, and the average height was in a range of 50 μm or more and 70 μm or less. That is, it can be seen that a structure having a scale larger than the wavelength of objective light (for example, visible light) to be prevented from being reflected is formed.

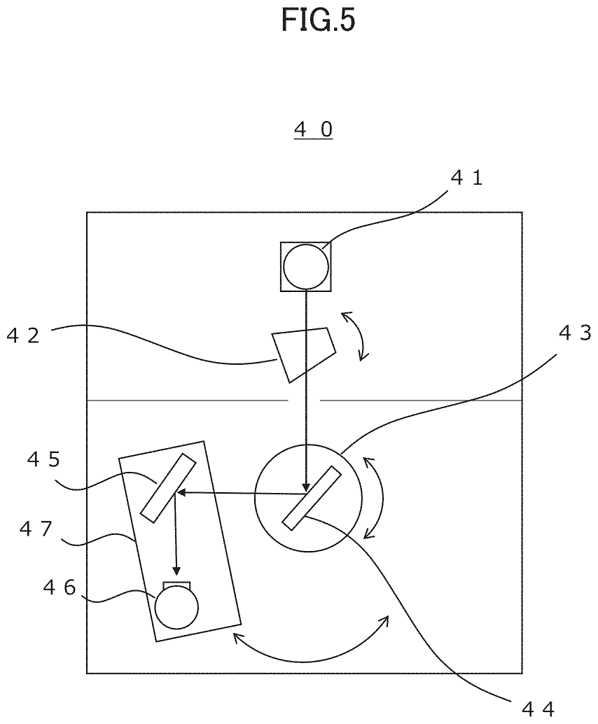

Next, an example of comparing antireflection characteristics between the antireflection structure according to the present embodiment and the moth-eye structure will be described. FIG. 5 is a schematic diagram for explaining a reflectance measurement system 40 used for comparing antireflection characteristics. Light of a halogen lamp 41 is dispersed by a prism 42, and a measurement object 44 is irradiated with reference light of which a wavelength is selected through a slit. The measurement object 44 is set on a rotary stage 43, and an incident angle of the reference light with respect to the measurement object 44 can be changed by rotating the rotary stage 43. The reference light reflected by the measurement object 44 is guided to an integrating sphere 46 via a mirror 45. The mirror 45 and the integrating sphere 46 are placed on the stage 47, and by moving the stage 47, it is possible to set the angle of the light to be detected among the light emitted from the measurement object 44. As a reference of the reflectance measurement, when the entire reference light is put into the integrating sphere 46 without installing the measurement object on the rotary stage 43, a measurement value is set to reflectance 100%. In addition, a light shielding plate is installed on the rotary stage 43, an incident angle is set to 0 degrees, and a measurement value when light to the integrating sphere 46 is completely blocked is set to reflectance 0%. An absolute value reflectance of the measurement object 44 is measured using this standard.

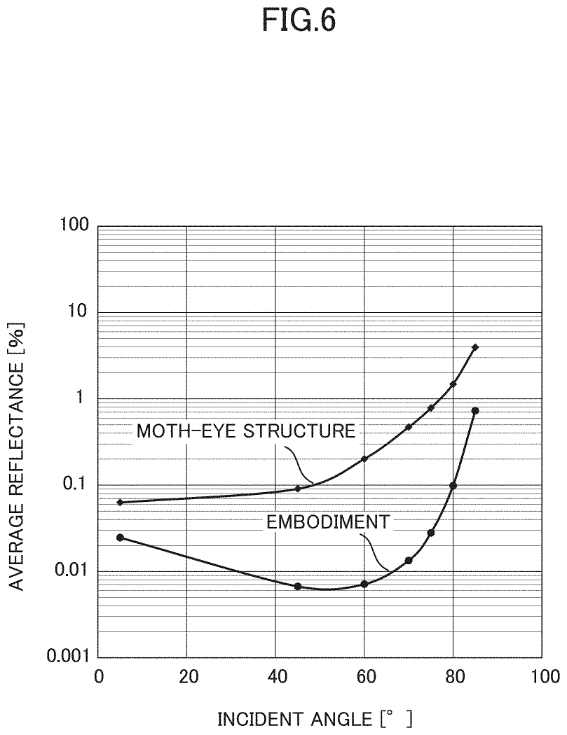

FIG. 6 is a graph illustrating a relationship between the incident angle and the average reflectance measured by the method described above, in which a horizontal axis represents the incident angle of light with respect to the extension direction of the convex portion, and a vertical axis represents the average reflectance. Note that the average reflectance is obtained by measuring the reflectance while changing a wavelength of irradiation light in the range of 350 nm to 800 nm in increments of 10 nm, and taking the average value thereof as the average reflectance. The incident angle of the irradiation light is set and measured in 7 directions of 0 degrees, 45 degrees, 60 degrees, 70 degrees, 75 degrees, 80 degrees, and 85 degrees, and the emission angle is the same as the incident angle in order to measure the specular reflection component. For the measurement, an absolute reflectance measuring instrument of JASCO Corporation is used.

In the antireflection structure according to the embodiment, as described above, the average pitch of the protrusions is in the range of 20 μm or more and 50 μm or less, and the average height is in the range of 50 μm or more and 70 μm or less. The moth-eye structure conforms to that described in JP 2014-6390 A, and is a minute structure in which a pitch of minute protrusions is 100 nm to 300 nm.

As is apparent from FIG. 6, when the average reflectance in the wavelength range of 350 nm to 800 nm is compared, it is found that the antireflection structure of the present embodiment has a lower reflectance than the moth-eye structure over the entire range of incident angles. In addition, the antireflection structure of the present embodiment exhibits particularly low reflectance with respect to a light beam incident from a direction of 45 degrees or more and 60 degrees or less, and it can be seen that the incident angle at which the reflectance is minimized exists within this range. Therefore, in the optical unit illustrated in FIG. 1, the antireflection structure in which the extension direction of the convex portion is 45 degrees or more and 60 degrees or less with respect to the optical axis can exhibit an extremely excellent antireflection function.

### Second Embodiment

An optical unit including an antireflection structure according to a second embodiment will be described with reference to the drawings. Note that, in the drawings referred to below, there is a portion schematically represented for convenience of illustration and description, and thus, there is a case where the shape, size, arrangement, and the like are not exactly matched with the actual shape, size, arrangement, and the like.

### Configuration of Optical Unit

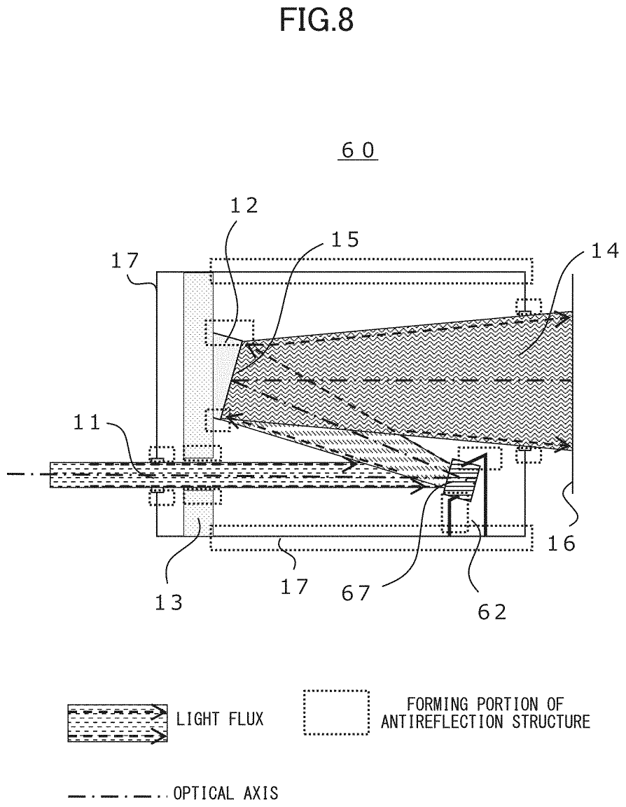

FIG. 8 is a diagram illustrating a configuration of an optical unit 60 according to a second embodiment. Components common to the first embodiment are denoted by the same reference numerals in the drawings, and the description thereof is simplified or omitted.

In the optical unit 60 according to the present embodiment, a reflection type diffraction grating is used for at least a part of the reflection unit. In the optical unit 60 illustrated in FIG. 8, the reflection unit 15 is a mirror, but a reflection type diffraction grating is used for a reflection unit 67. The optical unit 60 of the present embodiment also has an antireflection structure similar to that described with reference to FIG. 2 and the like in the first embodiment, but there is a difference in a position where the antireflection structure is provided.

In the present embodiment, the antireflection structure is similarly provided in the vicinity of the incidence portion 11 on which the light flux emitted from the object surface is incident, in the vicinity of the transmission portion provided in the structural member, in the vicinity of the support unit 12 supporting the reflection unit 15 or the support unit 62 supporting the reflection unit 67, or in the vicinity of the emission portion 14. However, from the reflection type diffraction grating of the reflection unit 67, diffracted light diffracted in a range of about ±1 order and ±2 order with respect to a desired diffraction order may be emitted in a direction different from a useful light flux. Therefore, in the optical unit using the reflection type diffraction grating, unnecessary diffracted light may fly to the inner surface of the casing 17, and the casing may reflect the diffracted light to generate stray light. Therefore, in the present embodiment, as surrounded by dotted lines in the drawing, an antireflection structure is provided on the inner surface of the casing 17, particularly, a portion visible from the diffraction grating. Note that it is also effective to provide an antireflection structure not only on the inner surface of the casing 17 but also on a structural material visible from the diffraction grating.

The present embodiment can be suitably implemented in various optical devices including a spectroscopic analyzer, for example, an optical unit built in an astronomical telescope, a microscope, various cameras, or the like. According to the present embodiment, it is possible to suppress generation of stray light due to reflection of unnecessary light deviating from the principal light beam by a minute angle on the member, and thus, it is possible to effectively prevent deterioration in performance of the spectroscopic analyzer. Furthermore, it is possible to suppress generation of stray light due to reflection of diffracted light of an unnecessary order emitted from the reflection type diffraction grating on a casing or the like.

### Third Embodiment

An optical unit including an antireflection structure according to a third embodiment will be described with reference to the drawings. Note that, in the drawings referred to below, there is a portion schematically represented for convenience of illustration and description, and thus, there is a case where the shape, size, arrangement, and the like are not exactly matched with the actual shape, size, arrangement, and the like.

### Configuration of Optical Unit

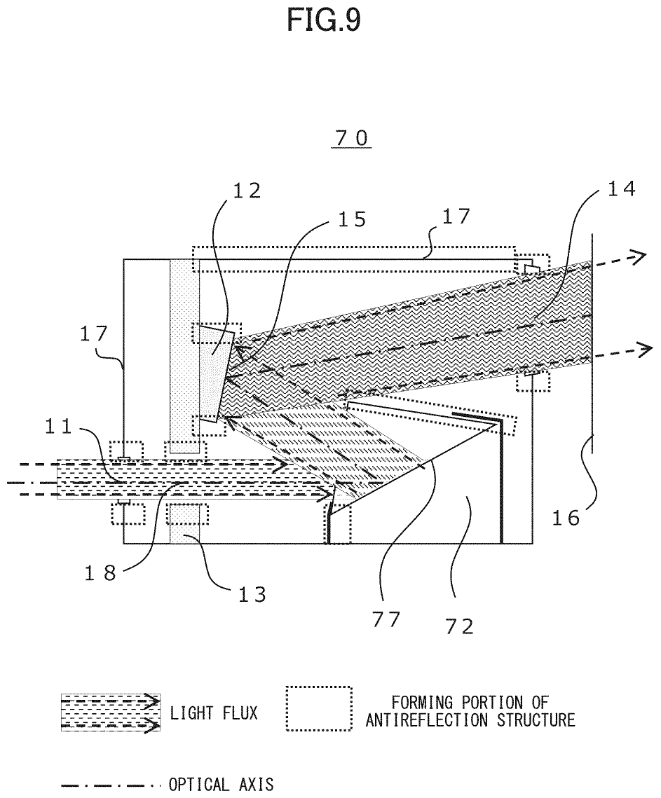

FIG. 9 is a diagram illustrating a configuration of an optical unit 70 according to the third embodiment. Components common to the first embodiment are denoted by the same reference numerals in the drawings, and the description thereof is simplified or omitted.

In the optical unit 70 according to the present embodiment, a transmissive inner reflection type diffraction grating (also referred to as an immersion diffraction grating) is used for at least a part of the reflection unit. In the optical unit 70 illustrated in FIG. 9, the reflection unit 15 is a mirror, but a transmissive inner reflection type diffraction grating is used for a reflection unit 77. The optical unit 70 of the present embodiment also has an antireflection structure similar to that described with reference to FIG. 2 and the like in Embodiment 1, but there is a difference in a position where the antireflection structure is provided.

In the present embodiment, the antireflection structure is similarly provided in the vicinity of the incidence portion 11 on which the light flux emitted from the object surface is incident, in the vicinity of the transmission portion provided in the structural member, in the vicinity of the support unit 12 supporting the reflection unit 15 or the support unit 72 supporting the reflection unit 77, or in the vicinity of the emission portion 14. However, diffracted light diffracted in a range of about ±1 order and ±2 order with respect to a desired diffraction order may be emitted in a direction different from a useful light flux from the reflection unit 77 which is a transmissive inner reflection type diffraction grating. In addition, diffracted light deviated from the useful light flux may be further reflected by an inner surface of a transmissive element and emitted in another direction to become stray light. For this reason, in the optical unit using the transmissive inner reflection type diffraction grating, unnecessary diffracted light may fly to the inner surface of the casing 17, and the casing may reflect the diffracted light to generate stray light. Therefore, in the present embodiment, as surrounded by dotted lines in the drawing, an antireflection structure is provided on the inner surface of the casing 17, particularly, a portion visible from the diffraction grating. Note that it is also effective to provide an antireflection structure not only on the inner surface of the casing 17 but also on a structural material visible from the diffraction grating or the support unit 72 of the diffraction grating.

The present embodiment can be suitably implemented in various optical devices including a spectroscopic analyzer, for example, an optical unit built in an astronomical telescope, a microscope, various cameras, or the like. According to the present embodiment, it is possible to suppress generation of stray light due to reflection of unnecessary light deviating from the principal light beam by a minute angle on the member, and thus, it is possible to effectively prevent deterioration in performance of the spectroscopic analyzer. Furthermore, it is possible to suppress generation of stray light due to reflection of diffracted light of an unnecessary order emitted from the transmissive inner reflection type diffraction grating on a casing or the like.

### Fourth Embodiment

An optical unit including an antireflection structure according to a fourth embodiment will be described with reference to the drawings. Note that, in the drawings referred to below, there is a portion schematically represented for convenience of illustration and description, and thus, there is a case where the shape, size, arrangement, and the like are not exactly matched with the actual shape, size, arrangement, and the like.

### Configuration of Optical Unit

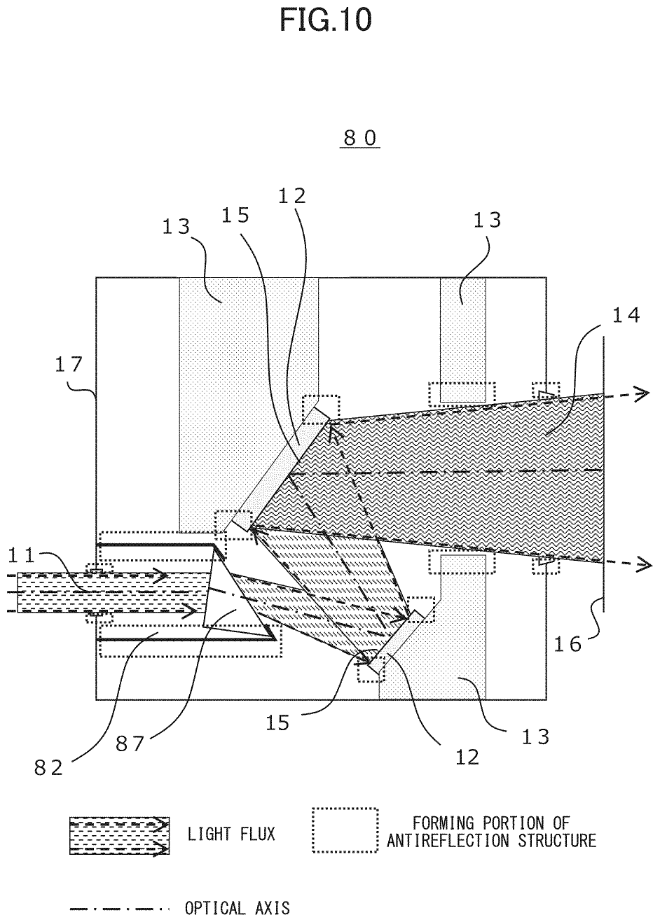

FIG. 10 is a diagram illustrating a configuration of an optical unit 80 according to the fourth embodiment. Components common to the first embodiment are denoted by the same reference numerals in the drawings, and the description thereof is simplified or omitted.

In addition to the reflection unit 15, the optical unit 80 according to the present embodiment includes a transmission type diffraction grating 87 (which may be referred to as a grism diffraction grating) and a support unit 82 thereof. The optical unit 80 of the present embodiment also has an antireflection structure similar to the antireflection structure described with reference to FIG. 2 and the like in the first embodiment, but there is a difference in a position where the antireflection structure is provided.

In the present embodiment, the antireflection structure is similarly provided in the vicinity of the incidence portion 11 on which the light flux emitted from the object surface is incident, in the vicinity of the transmission portion provided in the structural member 13, in the vicinity of the support unit 12 that supports the reflection unit 15, or in the vicinity of the emission portion 14. However, from the transmission type diffraction grating 87, diffracted light diffracted in a range of about ±1 order and ±2 order with respect to a desired diffraction order may be emitted in a direction different from a useful light flux. Therefore, in the optical unit using the transmission type diffraction grating 87, unnecessary diffracted light may fly to the inner surface of the casing 17, the support unit 82, the structural member 13, and the like, and may be reflected to become stray light. Therefore, in the present embodiment, as surrounded by dotted lines in the drawing, an antireflection structure is provided on the inner surface of the casing 17, the support unit 82, and a portion of the structural member 13, particularly visible from the transmission type diffraction grating 87.

The present embodiment can be suitably implemented in various optical devices including a spectroscopic analyzer and a lens that guides light to the spectroscopic analyzer, for example, an optical unit built in an astronomical telescope, a microscope, various cameras, or the like. According to the present embodiment, it is possible to suppress generation of stray light due to reflection of unnecessary light deviating from the principal light beam by a minute angle on the member, and thus, it is possible to effectively prevent deterioration in performance of the spectroscopic analyzer. Furthermore, it is possible to suppress generation of stray light due to reflection of diffracted light of an unnecessary order emitted from the transmission type diffraction grating on a casing or the like.

Note that the present invention is not limited to the embodiments and examples described above, and many modifications can be made within the technical idea of the present invention. For example, the different embodiments and examples described above may be implemented in combination.

### Other Embodiments

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2022-45094, filed Mar. 22, 2022, which is hereby incorporated by reference herein in its entirety.

What is claimed is:

1. An optical unit comprising:
a reflective optical element; and
an antireflection structure having an average height and an average pitch larger than a maximum wavelength of light contained in an effective light flux, disposed outside an optical path of the effective light flux, including a plurality of convex portions extending in a predetermined direction,
wherein an angle formed between the predetermined direction and the optical path of the effective light flux is from 45 degrees to 60 degrees.

2. The optical unit according to claim 1,
wherein the plurality of convex portions has an oxide coating.

3. The optical unit according to claim 1,
wherein a main component of the plurality of convex portions is a metal or an alloy.

4. The optical unit according to claim 1, wherein apexes of the plurality of convex portions have curvature.

5. The optical unit according to claim 1, wherein plural convex portions arranged at a pitch smaller than a pitch of the plurality of convex portions are formed on surfaces of the plurality of convex portions.

6. The optical unit according to claim 1,
wherein an incident angle of light having a minimum reflectance in the antireflection structure is within a range of 45 degrees or more and 60 degrees or less with respect to the predetermined direction in which the plurality of convex portions extend.

7. The optical unit according to claim 1,
wherein the antireflection structure is provided beside an incidence portion through which the effective light flux enters the optical unit and/or an emission portion through which the effective light flux is emitted from the optical unit.

8. The optical unit according to claim 1, wherein
the antireflection structure is provided in a support unit that supports the reflective optical element.

9. The optical unit according to claim 8,
wherein a material of the support unit is any one of a low thermal expansion invar material, a stainless-steel material, and aluminum.

10. The optical unit according to claim 1,
wherein the antireflection structure is provided on an inner surface of a casing of the optical unit and/or a surface of a structural member of the optical unit.

11. The optical unit according to claim 1,
wherein the antireflection structure is provided at a position visible from the reflective optical element.

12. The optical unit according to claim 1,
wherein the plurality of convex portions is formed on a base portion of which main component being the same as the plurality of convex portions.

13. The optical unit according to claim 1,
wherein the plurality of convex portions is formed on a member of which main component being a resin material.

14. The optical unit according to claim 1,
wherein the reflective optical element is any one of a minor, a reflection type diffraction grating, and a transmissive inner reflection type diffraction grating.

15. The optical unit according to claim 1,
further comprising a transmission type diffraction grating.

16. The optical unit according to claim 1,
further comprising a light receiving element.

17. A spectroscopic analyzer comprising: the optical unit according to claim 1; and a casing supporting the optical unit.

18. An optical device comprising: the spectroscopic analyzer according to claim 17; and a lens configured to guide light to the spectroscopic analyzer.

19. A method for manufacturing the optical unit according to claim 1,
the method comprising irradiating a parent material whose main component is a metal or an alloy with a picosecond laser or a femtosecond laser to form the plurality of convex portions.

20. The method for manufacturing the optical unit according to claim 19, further comprising irradiating the picosecond laser or the femtosecond laser in an atmosphere where oxygen exists to form an oxide film on the plurality of convex portions.
